(19) United States
(12) Patent Application Publication
(10) Pub. No.: US 2004/0098264 A1
(43) Pub. Date: May 20, 2004

(54) Method and apparatus for an interactive voice response system

(75) Inventors: Ronald John Bowater, Romsey (GB); Samuel Jonathan Smith, Southampton (GB)

Correspondence Address: Leslie A. Van Leeuwen, IBM Corp, IP Law, 11400 Burnett Road, Zip 4054, Austin, TX, 78758, US

(73) Assignee: International Business Machines Corporation, Armonk, NY

(21) Appl. No.: 10/434,504

(22) Filed: May 8, 2003

(30) Foreign Application Priority Data
Nov. 14, 2002 (GB) 0226520.5

(51) Int. Cl. G10L 21/00

(52) U.S. Cl. 704/270

(57) ABSTRACT

A method in an interactive voice response (IVR) system connected in a computer network for receiving a voice prompt in the form of streaming voice data from a node in the network and playing the received voice data out on an IVR channel, said voice data representative of alternate periods of utterances and periods of natural silence, said method comprising: storing the voice data received from the node; identifying, in the buffer, whole sequences of voice data comprising an utterance between natural silence; and playing out voice data on an IVR channel if the voice data forms a whole sequence of voice data in the buffer.

### FIELD OF THE INVENTION

This invention relates to a method and apparatus for an interactive voice response system.

### BACKGROUND OF THE INVENTION

A telephone can be used to place a catalogue order; check an airline schedule; query a price; review an account balance; notify a customer; record and retrieve a message; and other business services. Often, each telephone call involves a service representative talking to a user, asking questions, entering responses into a computer, and reading information to the user from a terminal screen. This process can be automated by substituting an interactive voice response system (IVR) with an ability to play voice prompts and receive user input e.g. from speech recognition or from DTMF tones.

An interactive voice response system is typically implemented using a client server configuration where the telephony interface and voice application run on the client machine and voice data supply server software such as text-to-speech or a voice prompt database runs on a server with a local area network connecting the two machines. When the application requires voice data it requests a voice server to start streaming the voice data to the client. The client will wait until a certain amount of voice data has been accumulated in a buffer and then starts playing voice data to an open telephony channel.

Any delay up to the point at which a play out operation is started is perceived as an initial delay which is relatively harmless. However, once the play has started, the voice data must feed the open telephony channel at a constant flow, e.g. 8 Kbytes per second, with the manifestation of a break in this flow being perceived as a voice quality problem, e.g. a stutter or a click.

Maintaining a constant voice data flow to a telephony channel is a real problem in a voice server. If the flow is delayed, voice data will only continue to play from the buffer while there is voice data left in the buffer. When the voice buffer is fully depleted there are only two alternatives: 1) stop the entire streaming and play out operation with an error or 2) fill time until new voice data arrives, for example with artificial silence. The problem increases if the connection between the client and server is more remote than a LAN such as a wide area network or the Internet. With the growth of VoiceXML applications, such distant clients and servers are on the increase.

Furthermore it is likely that the LAN or another network is handling the voice server traffic for many channels concurrently. The network may also be handling other data traffic. Both factors increase the chance that voice packets will be delayed as they travel through the network. Routers, gateways, etc. between the IVR and voice servers would also add to the overall network delay.

One present solution to this problem is to use a large buffer on the client such that enough data is held in the buffer to handle the longest gap in the voice data being received from the voice server. However, this can give rise to a long delay at the start of an operation while the buffer is being filled.

### DISCLOSURE OF THE INVENTION

According to a first aspect of the present invention there is provided an interactive voice response (IVR) system connected in a computer network for receiving a voice prompt in the form of streaming voice data from a node in the network and playing the received voice data out on an IVR channel, said voice data representative of alternate periods of utterances and periods of natural silence, said IVR system comprising:

a buffer for storing the voice data received from the node;

a sequence controller for identifying sequences of voice data, each sequence comprising an utterance between natural silence; and

a play out controller for playing out a sequence of voice data on an IVR channel when a whole sequence of voice data is received in the buffer. In this way, if there is a discontinuity in the play out of the voice data it will occur during the natural silence.

The sequence controller scans incoming voice data for sound or silence. The voice data between two sequential periods of silence is identified as a sequence forming a whole utterance. Each period of silence must be more than a minimum period otherwise small gaps between some phonemes will be counted and a word may count as two utterances. In the preferred embodiment the sequence controller processes the voice data to distinguish between voice data representing sound and voice data representing silence. In a second and third embodiment the IVR sequence controller scans for a tag in the voice data identifying a sound or silence, the tag being introduced into the voice data by a remote sequence controller processing the voice data to distinguish between sound and silence.

The prompt is stored in the buffer in the form of packets of voice data and the sequence controller scans each voice packet for sound or silence. In the preferred embodiment the voice packets are small enough so that a single voice packet can be counted as a unit of sound or silence. The preferred packet size is between 10 and 50 msec, with 20 msec as the optimal size for interactive voice where two people are speaking to each other. However when one of the parties is an IVR for example the packets can be larger e.g. up to one second. Each voice packet is marked as voice or silence. A tag may be placed in a header of a voice packet or in a payload part of the voice packet. The packets stored in the voice buffer are the same as the packets transmitted across the network and are not serialised by a transport controller before being placed in the voice buffer.

An advantageous way of tagging the packet is to make the payload part of the voice packet null if there is silence. A non-zero value will indicate a sound. Another advantageous way is to mark the header of the packet with a value to identify sound or silence.

Suitably if the sequence controller identifies a sequence of data to be played in the buffer then that sequence will be made available for play. A sequence becomes current when it is the next sequence to be played. The sequence controller acquires, for the current sequence, start and finish packet numbers in the buffer.

In the preferred embodiment, voice packets sent from a voice prompt database or a TTS engine are processed in the IVR to identify sequences of voice and silence data. This allows for any voice server to send voice data to the present embodiment. However, an IVR is performing many channels of voice data processing and its digital signal processing resources are finite. Therefore it would be advantageous for networked servers to perform the signal processing instead.

In the second embodiment, processing of the voice data is performed at the voice server and tags are used to mark the sequences in the packet data. The sequence controller in the IVR now only scans voice data for tags which frees up digital signal processing resources at the IVR.

Moreover, in the second embodiment, once a voice prompt has been processed and tagged to mark utterance sequences there is no need to process it again and it may be stored in a voice prompt database for later retrieval already tagged for use.

However, it is not always necessary to perform digital signal processing on voice data. In the third embodiment, a TTS engine identifies a whole utterance in text data by scanning for spaces between text words and punctuation and embeds voice prompts with tags to mark the whole utterances. For TTS, therefore, there is no need to use digital signal processing to scan voice data for periods of silence. An utterance may be taken as a single word but in the third embodiment an utterance is a whole sentence as natural breaks in sound are more likely here. In alternative embodiments phrases separated by other punctuation marks may be taken as utterances.

According to a second aspect of the invention there is provided a method for playing out prompts within an IVR system as described in the claims.

According to a third aspect a computer program product is provided for processing one or more sets of data processing tasks, said computer program product comprising computer program instructions stored on a computer-readable storage medium for, when loaded into a computer and executed, causing a computer to carry out the steps as described in the claims.

### BRIEF DESCRIPTION OF THE DRAWINGS

In order to promote a fuller understanding of this and other aspects of the present invention, an embodiment of the invention will now be described, by means of example only, with reference to the accompanying drawings in which:

FIG. 1 shows a schematic diagram of an interactive voice response system (IVR) 100 and a voice server 102 according to the prior art;

FIG. 2 shows a graph indicating the time taken for packets of voice data to find their way through a typical prior art computer network;

FIG. 3 shows a typical prior art user interaction with an IVR connected to a network prompt database and a network TTS engine;

FIG. 4A,B,C shows an overview example of the prior art process;

FIG. 5A,B,C shows an overview example of the process according to the preferred embodiment of the present invention;

FIG. 6 shows a schematic diagram of the IVR according to a preferred embodiment of the present invention;

FIG. 7 shows the steps of the sequence controller according to the preferred embodiment of the present invention;

FIG. 8 shows the steps of the buffer controller method according to the preferred embodiment of the present invention;

FIG. 9A shows a buffer table according to the preferred embodiment of the present invention;

FIG. 9B shows a buffer register according to the preferred embodiment of the present invention;

FIG. 10 shows a voice server according to a second embodiment of the present invention; and

FIG. 11 shows a text to speech engine according to a third embodiment of the present invention.

### DESCRIPTION OF THE PREFERRED EMBODIMENTS

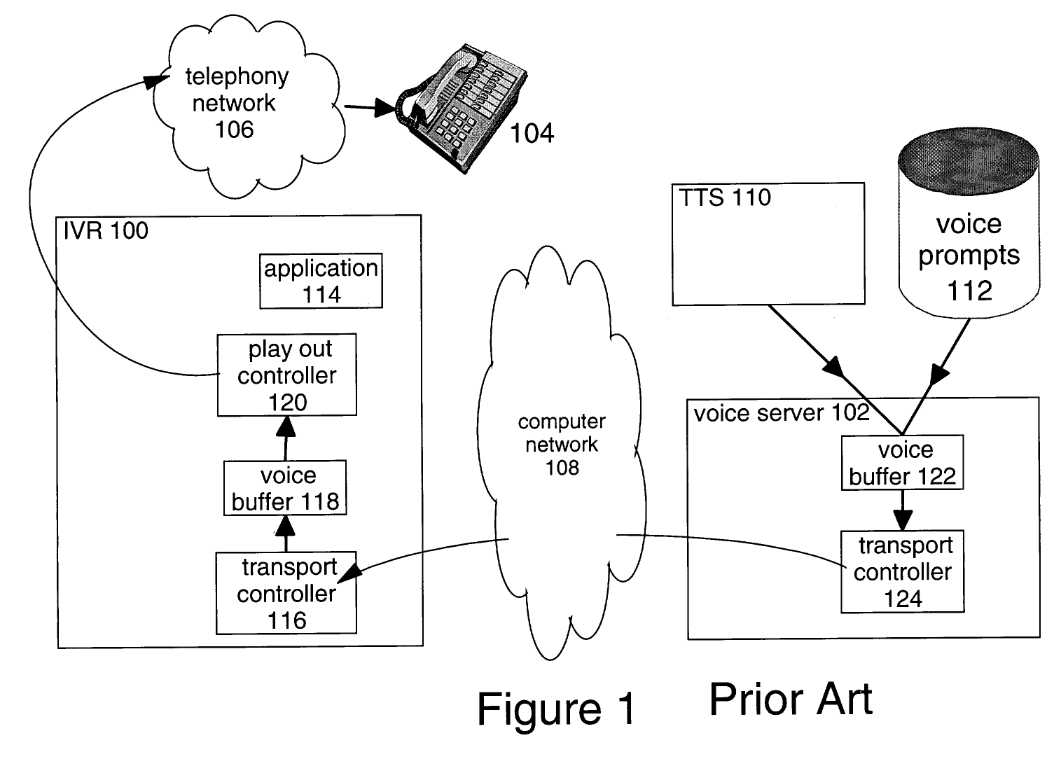

Referring to FIG. 1 there is shown a schematic diagram of an interactive voice response system (IVR) 100 and a voice server 102 according to prior art. A telephone 104 is connected, via a telephony network 106, to the interactive voice response system (IVR) 100. The IVR 100 is connected, via a computer network 108, to the voice server 102. The voice server 102 is connected to a text-to-speech engine (TTS) 110 and a voice prompt database 112.

The telephony network 106 is a public switched telephone network (PSTN). The computer network 108 is a local area network LAN.

The IVR 100 includes: an application 114; a transport controller 116; a voice buffer 118; and a play out controller 120. The voice server 102 includes: a voice buffer 122 and a transport controller 124. In normal operation voice data flows from the telephone 104, over the telephony network 106 into the IVR 100 on an open channel under the control of the application 114. Voice data also flows from TTS 110 or voice prompt database 112, via the voice server 102 and via the IVR 100, to the telephone 104. The voice data in the prompt database comprises pre-recorded voice prompts. The voice data from the TTS engine 110 comprises synthesised voice converted from text data.

IVR 100 comprises an IBM* WebSphere* Voice Response 3.1 (WVR) with IBM DirectTalk* Technology. In the preferred embodiment Java Beans and a Java application 114 are used to control the IVR 100. WVR is well-suited for large enterprises or telecommunications businesses. It is scalable, robust and designed for continuous operation 24 hours a day and 7 days a week. WebSphere Voice Response for AIX can support between 12 and 480 concurrent telephone channels on a single system. Multiple systems can be networked together to provide larger configurations. The preferred embodiment uses WebSphere Voice Response for AIX 3.1 which supports from 1 to 16 E1 or T1 digital trunks on a single IBM pseries* server with up to 1,500 ports on a single system. Over 2000 telephony channels using T1 or E1 connections can be supported in a 19″ rack. Network connectivity on multiple networks including PSTN, ISDN, CAS, SS7, VOIP networks is supported. The preferred embodiment is concerned with those networks which provide a user identification number with an incoming call e.g. ISDN and SS7. *AIX, DirectTalk, IBM, pseries, and WebSphere are trademarks of International Business Machines in the United States, other countries, or both.

Transport controller 116 receives and transmits the voice data over the computer network for the IVR 100. It receives packets of voice data and serialises the packets before storing them in the voice buffer 118. The transport protocol is TCP/IP. Transport controller 124 receives and transmits the voice data over the computer network in the voice server 102.

Voice buffer 118 stores voice data in serial form after it is received from the network and before they are played out by play out controller 120. Voice buffer 118 is a FIFO buffer so that data which is first in is also the first out. As data is input into one part of the buffer data from another part may be output. The amount of data within the buffer is constantly changing, decreasing if more data is output than input or increasing if more data is input than output.

Play out controller 120 moves serialised voice data from the buffer and plays it out over a voice channel. The voice buffer 118 has a lower threshold level indicating when the voice data in the IVR buffer is too low for play out. Play out controller 120 moves voice data only when the voice data level is above the lower threshold level. Play out controller 120 stops playing out voice data from the IVR buffer when the data level is below the lower threshold level. Play out controller 120 starts moving voice data again when the data level within the voice buffer 118 reaches an upper threshold level. A useful comparison is a water container which is filled from the top and has an outlet at the bottom, the amount of water reaches a certain level in the container. When the level of water in the container is below a lower threshold level no further water is allowed out. Water in the container must reach an upper threshold level before water is allowed out again. The lower threshold level does not effect the playing out of the last bytes of voice data stream and the IVR will play out the last bytes whether or not it is below the lower threshold level.

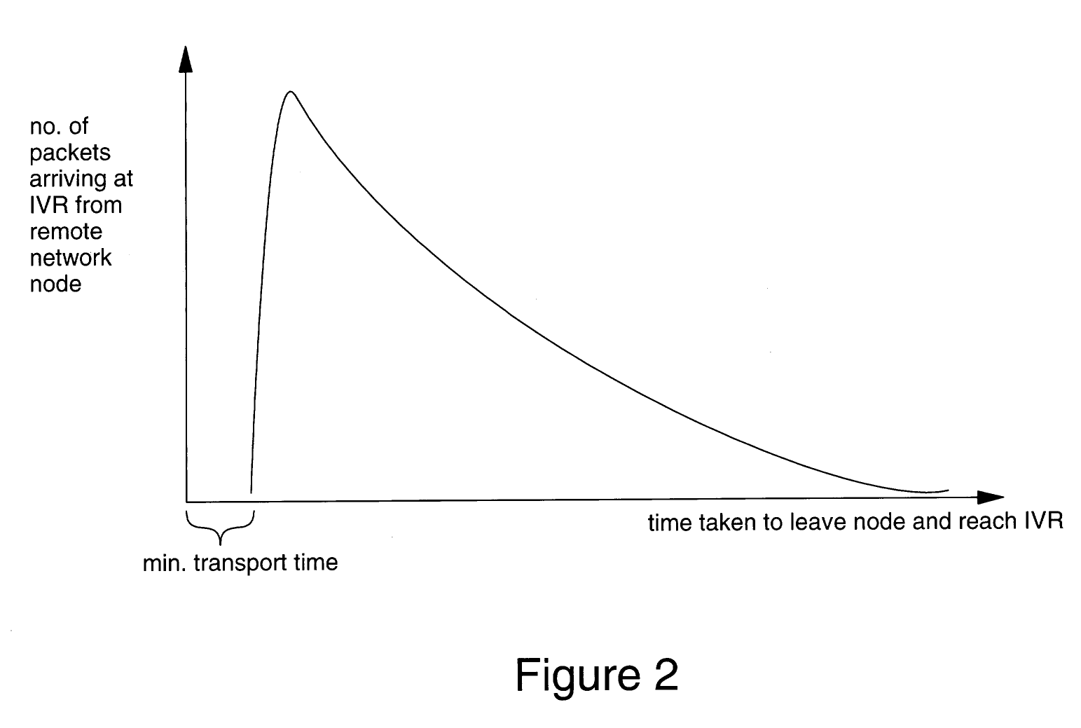

Referring to FIG. 2 there is shown a graph indicating the time taken for packets of voice data to find their way through a typical prior art computer network. The vast number of packets arrive within a certain time but the remainder of packets take longer to traverse the network due to network loading. The delay tails off exponentially as network load varies. There is a minimum time governed by the physical size of network.

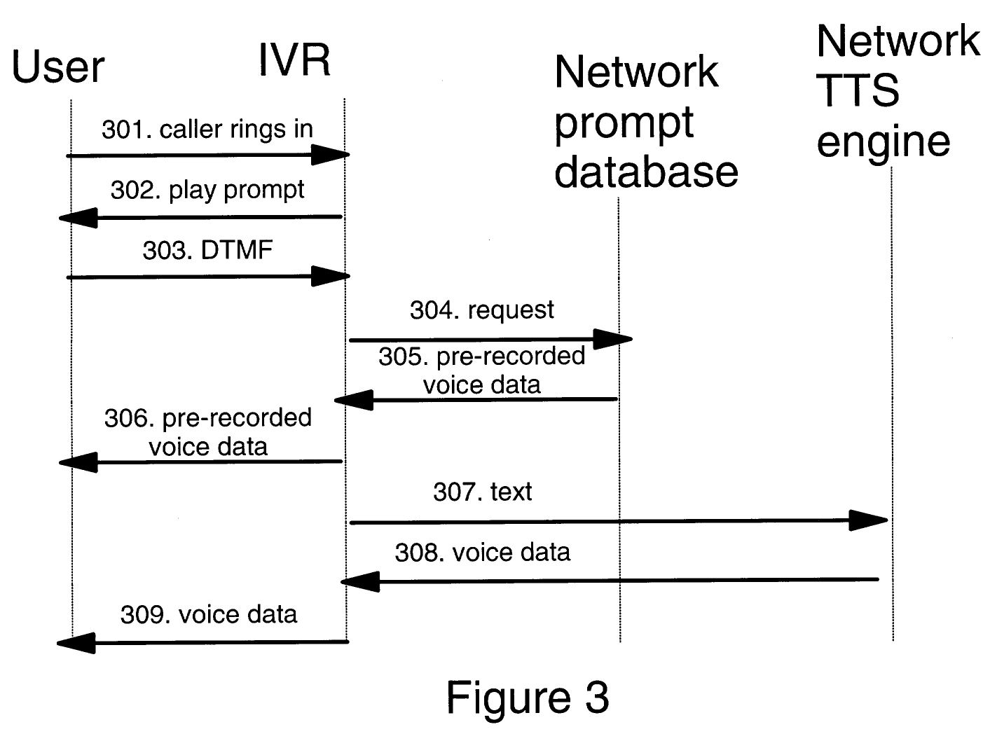

Referring to FIG. 3 there is shown a prior art user interaction with an IVR connected to a network prompt database and a network TTS engine. The interaction is depicted by steps 301 to 309. In step 301 the user rings the IVR, a voice channel is opened by the IVR and an IVR application 114 takes control of the voice channel. In step 302 the application 114 plays a first prompt to the user over the open channel. The first prompt is pre-recorded voice data stored by the application 114 on the IVR 100. The voice data may or may not be transferred to the buffer before play out. In step 303 DTMF (touch-tone) data is received from the user in response to the prompt. In step 304 a request is made to the prompt data base 112 for voice data. In step 305 the prompt database 112 returns voice data. over the network 108 into the buffer 118 of the IVR. In step 306 as the buffer 118 is being filled with voice data the application 114 plays the voice data as a second prompt to the user. In step 307 the application requests that the network text-to-speech engine 110 convert some text to voice data. In step 308 the text-to-speech engine 110 sends synthesised voice data over the network 108 to the buffer of the IVR 100. In step 309, as the buffer 118 is being filled with voice data the application 114 is playing the voice data as a third prompt out to the user. In each of the steps 305 and 308 voice data is being sent over a network 108 to an IVR 100, it is at these points that the problem of network delay would effect the continuity of voice data reception.

Voice data is sent over the network in discrete packets usually (but not necessarily) of a fixed length. In an Internet protocol network a packet comprises a TCP/IP header at the start of each voice packet and a ‘payload’ of the voice packet containing actual voice data. The voice data is usually represented using a 1-byte PCM format (mu or A-law formats) at the standard telephony sampling rate of 8 kHz i.e. a data rate of 8 Kbytes or 64 Kbits per second. A typical packet might contain 160 bytes corresponding to 20 milliseconds of voice. This means that, in order to sustain the 8 kHz data rate, it is necessary for the transmitter to send 50 packets per second.

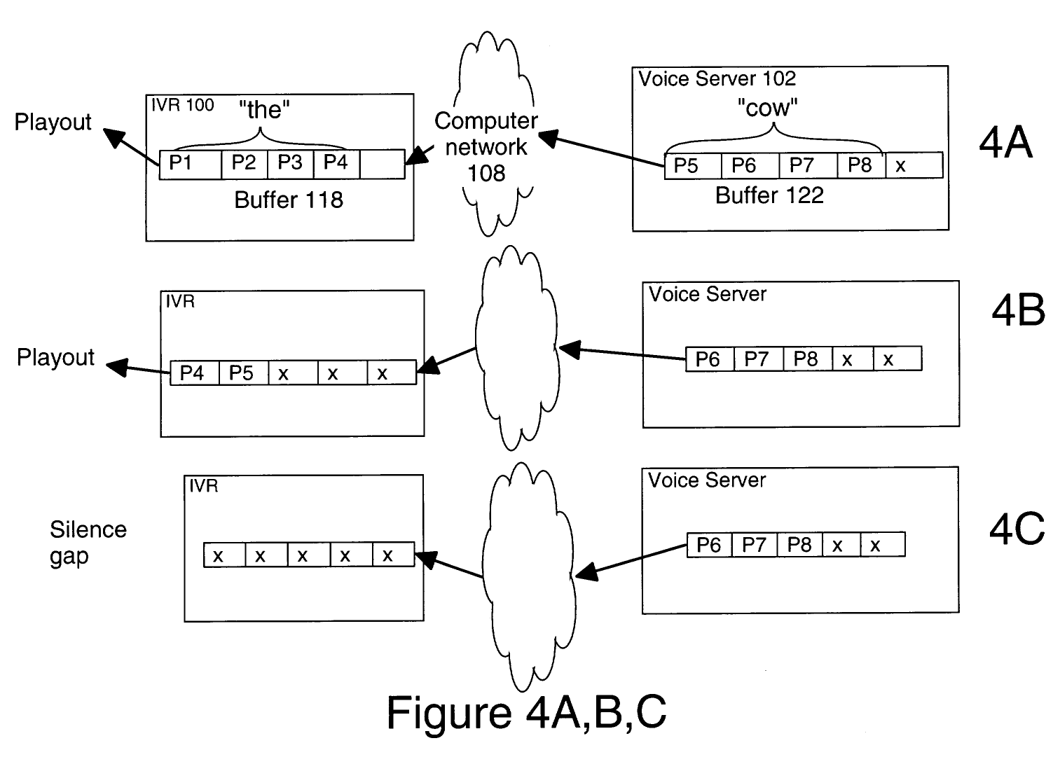

FIG. 4A,B,C gives an overview example of the prior art IVR voice data buffer at three different stages. Each of FIG. 4A,B,C show an IVR 100 and buffer 118 connected via computer network 108 to voice server 102 with buffer 122. The voice server generates voice packets at a rate which is lower or faster than the 8 kHz telephony rate. The voice data is being played out at a constant rate (8 kHz). P1,P2,P3,P4 represents the an utterance sequence of the word “the” and P5,P6,P7,P8 represents an utterance sequence of the word “cow”. Four packets P1,P2,P3,P4 are waiting in IVR buffer to be played out and there is spare capacity in the IVR buffer. For the sake of this example only, each of the packets is 200 ms which means that if another packet does not arrive within the next 800 ms, the buffer will be depleted and either an underrun error will occur, or it will be necessary to play silence at arbitrary points within the speech signal until the next packet arrives. Both of these are undesirable. FIG. 4B shows the case a stage further than FIG. 4A, the three packets P1,P2,P3 have been played out and another packet P5 has arrived from the voice server read for play out. Three more packets P6, P7,P8 have not cleared the network and are waiting the voice server buffer. FIG. 4C shows the situation a stage further than FIG. 4B, where packet P4 and P5 have been played but the other three packets P6,P7,P8 are still delayed. In this case, there is no option for the IVR other than to stop the operation with an underpin error, or to inject silence until an new packet arrives. Note that the silence has occurred between P5 and P6 and will cause a stutter effect. The occurrence of silence, in the prior art, is uncontrolled since it can happen between any packets.

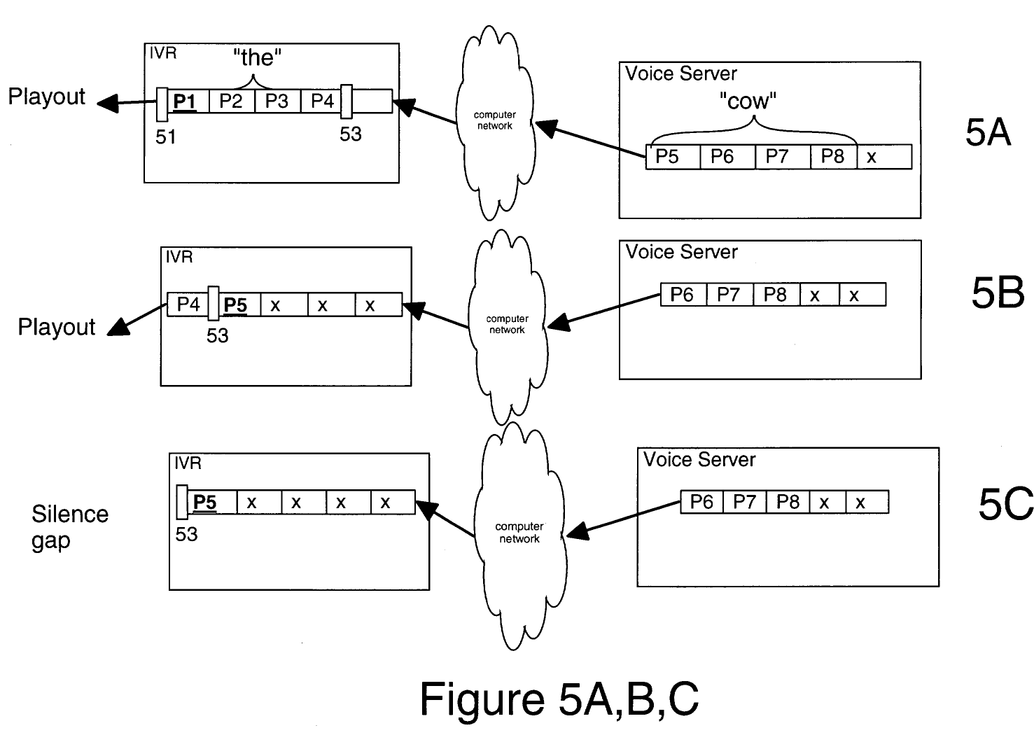

FIG. 5A,B,C gives an overview example of the IVR voice data buffer at three different stages according to the present embodiment. The embodiment proposes that silences in play out should occur at points where it is determined it is appropriate e.g. between a word or at a punctuation mark. FIGS. 5A,B,C are similar to FIG. 4A,B,C except now the result of the embodiment is described. The IVR identifies appropriate silence gaps in the data stream and inserts a tag at that point. The IVR only plays out data between two consecutive stages. As with FIG. 4A,B,C the IVR buffer contains packets P1,P2,P3,P4 representing the word ‘the’ and the voice server buffer contains packets P5,P6,P7,P8 representing the word ‘cow’. In this case though, a tag 51 precedes the first packet (P1) of the first word in the IVR buffer to identify a natural silence between words. Packet P5 is next to be received from the voice server. The IVR has also identified a silence gap in P4 and inserted tag 53 to identify it. In FIG. 5A,B,C, P1 and P5 are marked in bold and underlined to indicate the first packet of a word. Referring to FIG. 5B, packets P1,P2,P3 have been played out, P4 is about to be played out and P5 will be delayed until all the packets within the next silence gap are received. Packets P6,P7,P8 have not been sent and are delayed. Referring to FIG. 5C, packet P4 has been played out but P5 is not being played out (compare with FIG. 4C) because it is the first part of a word that has not fully arrived. Packets P6,P7,P8 have still not been sent and are delayed.

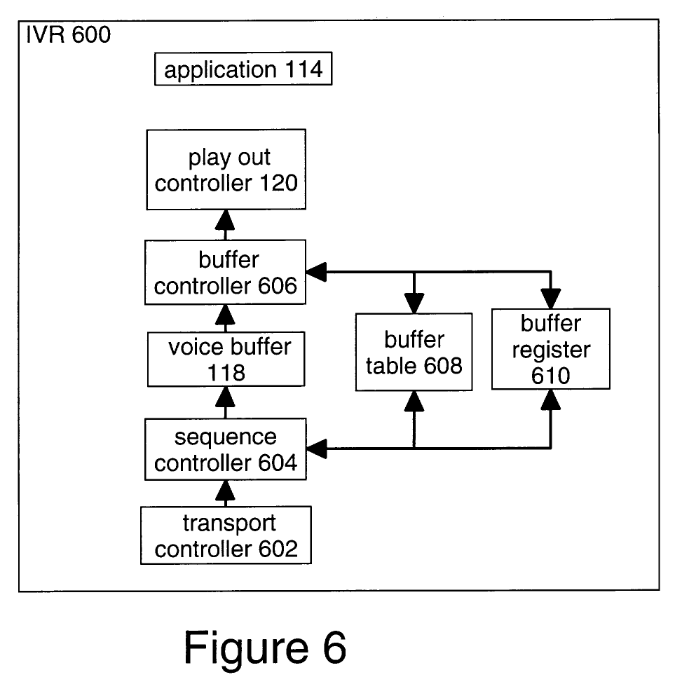

Referring to FIG. 6 there is shown a schematic diagram of the IVR 600 according to a first embodiment of the present invention. IVR 600 comprises components of the prior art IVR 100: application 114; voice buffer 118; play out controller 120. In addition IVR 600 also comprises new components: transport controller 602; sequence controller 604; buffer controller 606; buffer table 608; and buffer register 610.

Transport controller 602 receives packet data from the network 108 but does not serialise the voice data in the voice buffer 118. Instead the original packet structure is kept and stored in the voice buffer.

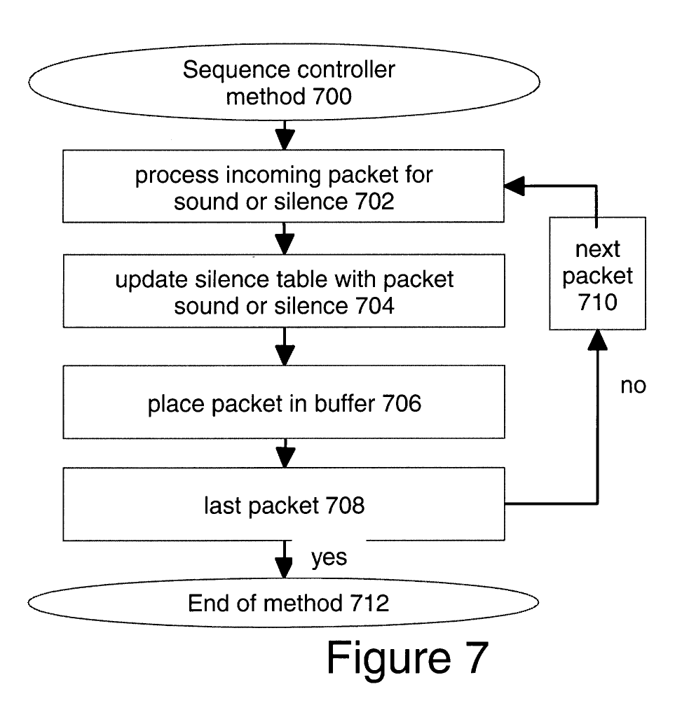

Sequence controller 604 intercepts voice packets as they arrive from the voice server 102 and processes the voice data to decide if the data is sound or silence. The sequence controller 604 updates buffer table 608 with the findings. Method 700 of the sequence controller 604 is described in relation to FIG. 7.

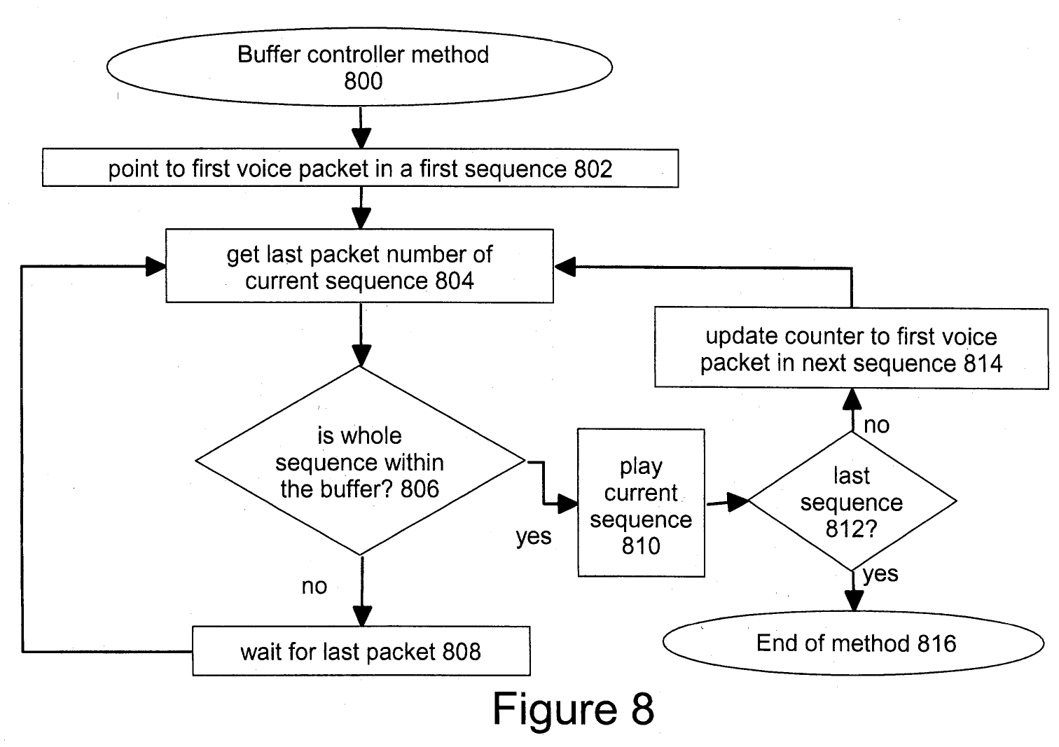

Buffer controller 606 analyses whether the current sequence of voice data for play out is within the buffer and whether play out of the current sequence would bring the buffer level below the lower threshold level. Method 800 of buffer controller 606 is described in relation to FIG. 8.

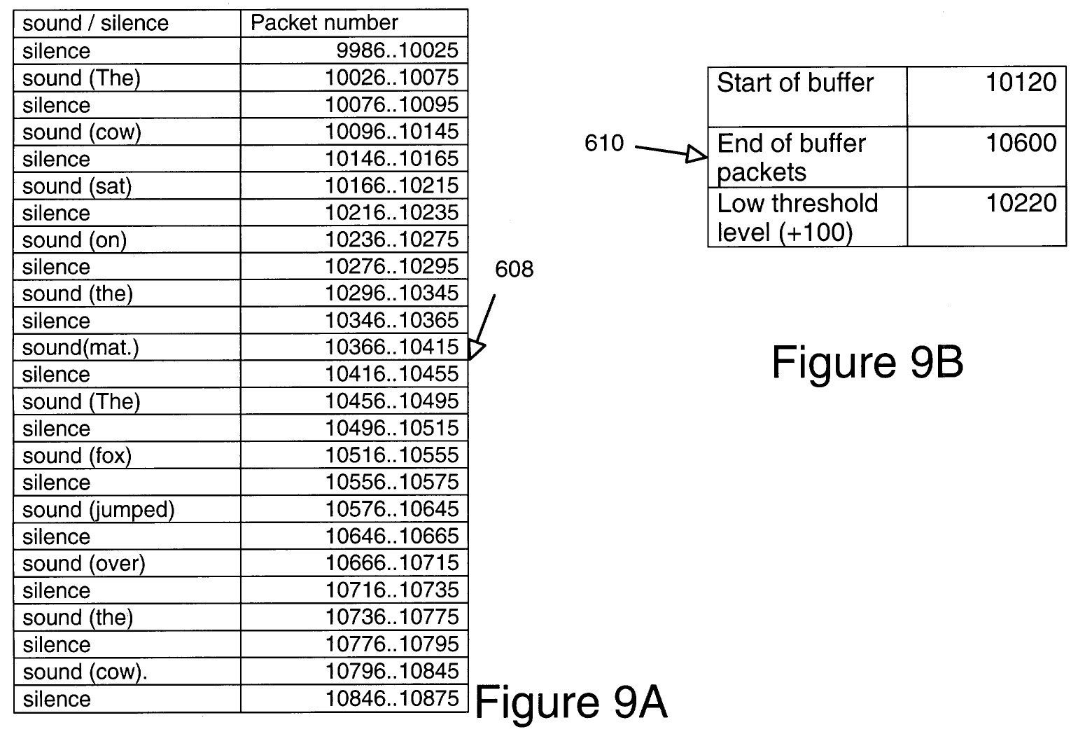

Buffer table 608 stores the voice and silence positions of the buffer. The sequence controller updates the buffer table 608 and the buffer controller 606 uses the buffer table 608 to control play out of the sequences if conditions are met. An example of the buffer table 608 is shown in FIG. 9A.

Buffer register 610 stores the start and end packet numbers and corresponding physical memory address of the buffer table 608. It also stores the low threshold level packet number. An example of the buffer register is shown in FIG. 9B. The start packet number and low threshold packet number is updated by the buffer controller 604. The end packet number is updated by the sequence controller 606.

Referring now to FIG. 7 there are shown the steps of the sequence controller method 700 according to the present embodiment. This method is continuous as long as incoming voice packets are received by the transport controller 602. Step 702 processes an incoming packet for sound or silence. When each packet is received is analyzed by a digital signal processor to decide whether it is sound or silence. A measurement of the energy of a voice packet is made as the energy level of a silence voice packet will be much lower than a voice packet containing actual voice. The step is performed by a digital signal processor. Step 704 updates the silence table with packet sound or silence. In this embodiment each alternating period of voice and silence is listed in terms of packet number beginning and end. Step 706 places packet in buffer. Next the packet is placed into the buffer. The packet will have a physical address in the buffer but the logical packet number is used here to describe the position of the packet in the buffer. Step 708 checks to see if the packet is last packet. If the packet is not the last packet then the next packet is processed in the same way once it is received. In step 710 the next packet is acquired and the method starts again at step 702. Step 712 is the end of method. If the packet is the last packet then the method is finished at step 712. In practice the process is generally continuous until the channel is closed.

Referring now to FIG. 8 there is shown the steps of the buffer controller method 800 according to the present invention. This method continues as long as there are sequences of voice data in the buffer. The initialization step 802 points at a first voice packet in a first sequence in the buffer and defines this as the current sequence. In step 804, the buffer controller attempts to acquire the last packet number of current sequence from the buffer table if it has been received. In step 806 the buffer controller checks that the whole sequence is in the buffer. In step 808 if the last packet has not been received then buffer controller waits for the last packet. Step 810 plays the current sequence if the last packet of the current sequence is in the buffer. In step 812, if the sequence is the last sequence in the prompt then this is the end of the method step 816. If the current packet is the last packet then at step 818 the counter is updated to point to the next sequence in the buffer table.

Instead of deciding whether the whole utterance is in the buffer, an alternative embodiment uses the concept of low and high threshold level in the buffer. In this alternative embodiment the low threshold level is a fixed number of data packets in the buffer. The start of the buffer is defined in terms of a packet number and is constantly updated as packets are played out, the low threshold level is a predetermined number of packets in advance of this. For example, a low threshold level could be 100 packets in advance of the start of the buffer. A sequence of voice packets may straddle the low threshold level. Step 806 is modified to take account of the low threshold level so that a sequence is played if the end packet in the sequence is above the low threshold level. For instance, with a low threshold level of 100 packets, if the start packet is less than 100 packets and the end packet is more than 100 packets from the beginning of the buffer then play out can occur. The important thing to note is that the whole sequence is played out despite the play out taking the buffer below the low threshold level. Alternatively step 806 is modified so that a sequence is played only if both the start and end packet are above the low threshold level. Using the low and high threshold levels play. out does not reoccur until the packets in the buffer reach the high threshold level or the last packets in the prompt are received.

Referring. to FIG. 9A there is shown a buffer table 608 with information created by the sequence controller 604 . The buffer table 608 has two columns, a first column indicating whether the packets are silence or sound and a second column listing the corresponding packet numbers. An utterance is a period of silence followed by a period of sound or vici versa.

Referring to FIG. 9B there is shown buffer register 610 comprising variables updated and used by sequence controller 604 and buffer controller 606. Buffer register 610 comprises variables for the start of the buffer (updated by the buffer controller 606); the end of the buffer (updated by sequence controller 604) and the low threshold level which in this example is always 100 packets more than the start of the buffer.

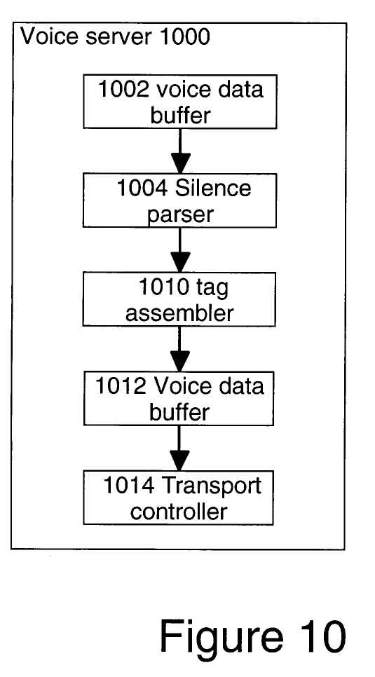

Referring to FIG. 10 there is shown a schematic voice server 1000 of the second embodiment. In this embodiment packets are identified as sound or silence packets in the voice server 1000 rather than in the IVR 100. Voice server 1000 comprises: a voice data buffer 1002; a silence parser 1004; a tag assembler 1010; voice data buffer 1012; and transport controller 1014. Voice data buffer 1002 receives data from, for example, text-to-speech server 110 or a voice prompt database 112. Silence parser 1004 performs the digital signal processing to determine whether a packet contains sound or silence. Tag assembler 1010 marks the packets with a tag to identify a sound or silence that is checkable by sequence controller 604. Voice data buffer 1012 holds the modified voice packets before sending to the IVR and transport controller 1014 affects transmission of the packets. In this embodiment the sequence controller 604 in IVR 100 scans for tags in the packets rather than processing the packet.

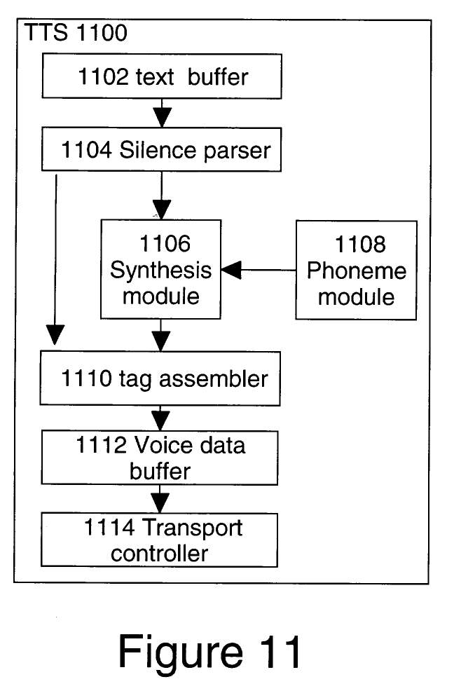

Referring to FIG. 11 there is shown a schematic text-to-speech server 1100 according to a third embodiment. In the third embodiment no digital signal processing is performed on voice packets to identify voice or silence in the voice server or IVR. Instead silences in a prompt are identified by spaces between text sentences and a silence tag is inserted between the voice data representing sequential sentences to identify a natural pause. Text-to-speech server 1100 comprises: text buffer 1102; silence parser 1104; synthesis module 1106; phoneme module 1108; tag assembler 1110; voice data buffer 1112 and transport 1114.

Text buffer 1102 holds the text to be converted into speech sent to it by an IVR. Silence parser 1104 breaks the text in the text buffer 1102 into utterances separated by pauses. In this embodiment a whole sentence is taken as the preferred silence but in other embodiments words or phrases may also be used. Each utterance is passed to the synthesis module 1106 and at the same time notification of the utterance is sent to the tag assembler 1110. Synthesis module 1106 maps the words of the utterance into phonemes and corresponding voice data from phoneme module 1108 and passes the voice data to tag assembler 1110. Tag assembler 1110 converts the voice data for each utterance into voice data packets and then marks the start and end packets as silence packets and the packets between as sound packets. The marked voice packets are temporarily stored in voice data buffer 1112 before transport controller 1114 transmits them to the voice server 102 and IVR 100. In this embodiment the sequence controller 117 in IVR 100 scans for tags in the packets rather than processing the packet.

In the preferred embodiment the telephony network is PSTN but any telephony network could be used such an ISDN or Voice over IP. Although in the preferred embodiment a LAN is used to connect the IVR to the voice server any network may be used including the Internet.

Although the embodiment has been described in terms of IBM WVR for AIX other IVRs can be used to implement the invention. For instance IBM WebSphere Voice Response for Windows* NT* and Windows 2000 with DirectTalk Technology is an interactive voice response (IVR) product that is. for users who prefer a Windows-based operating environment to run self-service applications. WebSphere Voice Response is capable of supporting simple to complex applications and can scale to thousands of lines in a networked configuration. Windows and Windows NT are trademarks of Microsoft Corporation in the United States, other countries, or both.

What is claimed is:

1. An interactive voice response (IVR) system connected in a computer network for receiving streaming voice data from a node in the network and playing the received voice data out on an IVR channel, said voice data representative of alternate periods of utterances and periods of natural silence, said IVR system comprising:
a buffer for storing the voice data received from the node;
a sequence controller identifying, sequences of voice data, each sequence comprising an utterance between natural silences; and
a play out controller for playing out voice data on an IVR channel when a sequence of voice data is received in the buffer.

2. A system as in claim 1 wherein the prompt is stored in the buffer in the form of packets of voice data and the sequence controller scans each voice packets for sound or silence.

3. A system as in claim 2 wherein each voice packet is marked as voice or silence.

4. A system as in claim 1 wherein a tag is placed in a voice packet to identify sound or silence.

5. A system as in claim 1 wherein the packets stored in the voice buffer are the same as the packets transmitted across the network.

6. A system as in claim 1 wherein a payload part of the voice packet is make null if it represents silence.

7. A system as in claim 1 where voice packets are processed in the IVR to identify sequences of voice and silence data.

8. A system as in claim 1 wherein processing of the voice data is performed at a voice server and tags are used to mark the sequences in the packet data.

9. A system as in claim 8 wherein, once a voice prompt has been processed and tagged to mark utterance sequences it is stored in a voice prompt database for later retrieval already tagged for use.

10. A system as in claim 1 wherein a TTS engine identifies a whole utterance in text data by scanning for spaces between text words and punctuation and embeds voice prompts with tags to mark the whole utterances.

11. A method in an interactive voice response (IVR) system connected in a computer network for receiving streaming voice data from a node in the network and playing the received voice data out on an IVR channel, said voice data representative of alternate periods of utterances and periods of natural silence, said method comprising:
storing the voice data received from the node;
identifying, whole sequences of voice data comprising an utterance between natural silence; and
playing out voice data on an IVR channel when a sequence of voice data is received in the buffer.

12. A computer program product for processing one or more sets of data processing tasks, said computer program product comprising computer program instructions stored on a computer-readable storage medium for, when loaded into a computer and executed, causing a computer to carry out the steps as claimed in claim 11.
